(19) United States
(12) Patent Application Publication
(10) Pub. No.: US 2019/0384109 A1
(43) Pub. Date: Dec. 19, 2019

(54) DISPLAY PANEL AND DISPLAY DEVICE

(71) Applicant: Wuhan China Star Optoelectronics Technology Co., Ltd., Wuhan, Hubei (CN)

(72) Inventor: Qi WEI, Wuhan, Hubei (CN)

(21) Appl. No.: 15/754,278

(22) PCT Filed: Jan. 17, 2018
(86) PCT No.: PCT/CN2018/073052

§ 371 Date: Feb. 21, 2018

(30) Foreign Application Priority Data
Nov. 28, 2017 (CN) 201711216670.7

(51) Int. Cl. G02F 1/1335; G02F 1/1343; G02F 1/1347; G02F 1/1333

(52) U.S. Cl. CPC G02F 1/133528; G02F 1/134309; G02F 2001/133538; G02F 1/133377; G02F 2001/133531; G02F 1/13471

(57) ABSTRACT

A display panel is provided, which includes a liquid crystal panel, a partitioning optical rotatory cell that is disposed opposite to the liquid crystal panel and a polarizer that is disposed on a side the partitioning optical rotatory cell facing away from the liquid crystal panel, in which a light transmission axis of the polarizer is perpendicular to or in parallel with a light transmission axis of a lower polarizer of the liquid crystal panel. The partitioning optical rotatory cell is configured to perform a regionally rotatory process on a polarization direction of illumination passing through the polarizer, such that different areas of the liquid crystal panel have different luminances. By inserting the partitioning optical rotatory cell in the liquid crystal panel to form the display panel of which different areas have different display luminances in a display status, such that the image contrast for display significantly increases.

### RELATED APPLICATIONS

The present application is a National Phase of International Application Number PCT/CN2018/073052, filed Jan. 17, 2018, and claims the priority of China Application 201711216670.7, filed Nov. 28, 2017.

### FIELD OF THE DISCLOSURE

The present invention belongs to a display technology field, and more particularly, the present invention relates to a display panel and a display device.

### BACKGROUND

Th evolution of photoelectric and semiconductor technology spurs the thriving development of flat panel display. Among a variety of flat panel displays, liquid crystal display (LCD) has been applied to various aspects of production and life as it is characterized by several superior characteristics, such as high space utilization efficiency, low energy consumption rate, zero radiation and low electromagnetic interference.

In recent years, continuous advancement of display technologies results in increasing requirements of users on display quality of an LCD (such as image resolution, color saturation, etc.). However, in addition to high image resolution and high color saturation, whether an LCD has high image contrast also becomes one demand factor for the users.

### SUMMARY

In order to solve the above problem existing in the prior art, the present invention aims to provide a display panel a display device which can achieve high image contrast.

According to one aspect of the present invention, a display device is provided, which includes a liquid crystal, a partitioning optical rotatory cell that is disposed opposite to the liquid crystal panel and a polarizer that is disposed on a side the partitioning optical rotatory cell facing away from the liquid crystal panel, in which a light transmission axis of the polarizer is perpendicular to or in parallel with a light transmission axis of a lower polarizer of the liquid crystal panel. The partitioning optical rotatory cell is configured to perform a regionally rotatory process on a polarization direction of illumination passing through the polarizer, such that different areas of the liquid crystal panel have different luminances.

In one embodiment, the partitioning optical rotatory cell includes a first substrate, a second substrate that is disposed facing and in parallel with the first substrate and plural liquid crystal grids that are disposed between the first substrate and the second substrate. Each liquid crystal grid has plural liquid crystal molecules therein, the liquid crystal molecules are arranged in a twisted nematic (TN) form, a long axis direction of the liquid crystal molecules is in parallel with the first substrate, and the liquid crystal molecules in each liquid crystal grid are twisted independently.

In one embodiment, the partitioning optical rotatory cell further includes plural first electrodes that are disposed on a surface of the first substrate facing the second substrate and are mutually independent, and includes plural second electrodes that are disposed on a surface of the second substrate facing the first substrate and are mutually independent. Each liquid crystal grid corresponds to a first electrode and a second electrode.

In one embodiment, the plural liquid crystal grids include at least one of a rectangular liquid crystal grid, a rhombus liquid crystal grid, a triangular liquid crystal grid, a regular pentagonal liquid crystal grid, a regular hexagonal liquid crystal grid and a regular octagonal liquid crystal grid.

In one embodiment, the plural liquid crystal grids are arranged in an array form and between the first substrate and the second substrate.

In one embodiment, the partitioning optical rotatory cell includes a first substrate, a second substrate that is disposed facing and in parallel with the first substrate and plural liquid crystal strips that are disposed between the first substrate and the second substrate. The plural liquid crystal strips are arranged in parallel with each other along a first direction, each liquid crystal strip extends along a second direction that is perpendicular to the first direction, each liquid crystal strip has plural liquid crystal molecules therein, the plural liquid crystal molecules are arranged in a twisted nematic form, a long axis direction of the liquid crystal molecules is in parallel with the first substrate, and the liquid crystal molecules of each liquid crystal grid are twisted independently.

In one embodiment, the partitioning optical rotatory cell further includes plural first electrode strips that are arranged in parallel with each other along the first direction and on a surface of the first substrate facing the second substrate and are mutually independent, and includes plural second electrode strips that are arranged in parallel with each other along the first direction and are disposed on a surface of the second substrate facing the first substrate and are mutually independent. Each liquid crystal strip corresponds to one of the first electrode strips and one of the second electrode strips.

In one embodiment, the liquid crystal panel includes a liquid crystal cell that is disposed opposite to the partitioning optical rotatory cell, the lower polarizer that is disposed between the liquid crystal cell and the partitioning optical rotatory cell and an upper polarizer that is disposed on a side of the liquid crystal cell facing away from the partitioning optical rotatory cell.

According to another aspect of the present invention, a display device is provided, which includes a backlight module and the abovementioned display panel, in which the backlight module is disposed on a side of the polarizer facing away from the partitioning optical rotatory cell.

In one embodiment, the backlight module is a side-edge backlight module or a direct backlight module.

The benefits of the present invention are as follows. In the embodiments of the present invention, a partitioning optical rotatory cell is inserted in a liquid crystal panel to form a display panel of which different areas have different display luminances in a display status, such that the image contrast for display significantly increases.

### BRIEF DESCRIPTION OF THE DRAWINGS

These and/or other aspects, characteristics and advantages of the embodiments in the present disclosure will become apparent and more readily appreciated from the following description, taken in conjunction with the accompanying drawings in which:

FIG. 1 is a schematic structure diagram of a display device according to one embodiment of the present invention.

FIG. 2 is a schematic cross sectional diagram of a partitioning optical rotatory cell according to one embodiment of the present invention.

FIG. 3 is a schematic diagram of liquid crystal grids disposed between the first substrate and the second substrate according to one embodiment of the present invention.

FIG. 4 is a schematic cross sectional diagram of a partitioning optical rotatory cell according to another embodiment of the present invention.

FIG. 5 is a schematic diagram of liquid crystal strips disposed between the first substrate and the second substrate according to another embodiment of the present invention.

### DETAILED DESCRIPTION OF PREFERRED EMBODIMENTS

Embodiments of the present disclosure will be described in detail below by referring to the accompany drawings. However, the present disclosure can be implemented in different manners and should not be interpreted to be confined to the specific embodiments elaborated hereby. Instead, these embodiments are provided for explaining the principle and actual application of the present invention, thus other skilled in the art can understand various embodiments and amendments which are suitable for specific intended applications of the present disclosure.

The drawings may also exaggerate the thickness of some layer or region for the sake of clarity. The same reference number always refers to the same element in the whole specification and the drawings.

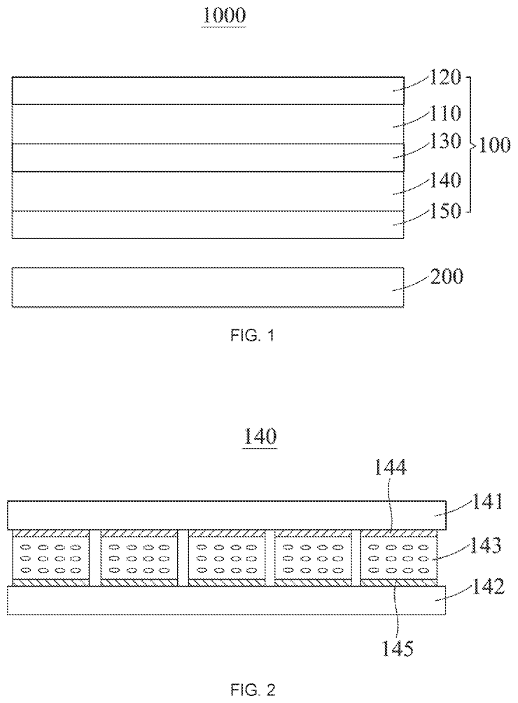

FIG. 1 is a schematic structure diagram of a display device 1000 according to one embodiment of the present invention.

Referring to FIG. 1, the display device 1000 according to one embodiment of the present invention includes a display panel 100 and a backlight module 200 disposed opposite to each other, in which the backlight module 200 provides display illumination for the display panel 100 to display accordingly. Here, it should be noted that the backlight module 200 may be, for example, a side-edge backlight module or a direct backlight module.

In particular, the display panel 100 is over the backlight module 200. The display panel 100 includes a liquid crystal cell 110, a first polarizer 120, a second polarizer 130, a partitioning optical rotatory cell 140 and a third polarizer 150.

The first polarizer 120 adheres to a first surface (i.e. an upper surface) of the liquid crystal cell 110, the second polarizer 130 adheres to a second surface (i.e. a lower surface) that is opposite to the first surface, the partitioning optical rotatory cell 140 is disposed on a surface of the second polarizer 130 facing away from the second surface, the third polarizer 150 adheres to a surface of the partitioning optical rotatory cell 140 facing away from the second polarizer 130, and the backlight module 200 is disposed at a side of the third polarizer 150 facing away from the partitioning optical rotatory cell 140. The light transmission axis of the third polarizer 150 is perpendicular to or in parallel with that of the second polarizer 130, the partitioning optical rotatory cell 140 is configured to perform a regionally rotatory process on a polarization direction of the illumination (i.e. the illumination emitted by the backlight module 200 and passing through the third polarizer 150), such that different areas of the liquid crystal panel formed by the liquid crystal cell 110, the first polarizer 120 and the second polarizer 130 have different luminances.

It is noted that, the display mode of the liquid crystal cell 110 according to the embodiment may be, for example, a liquid crystal cell that includes a TN display mode, an in-plane switching (IPS) display mode or a vertical alignment (VA) display mode, but the present invention is not limited thereto. In addition, the light transmission axis of the first polarizer 120 may be perpendicular to or in parallel with that of the second polarizer 130, but the present invention is not limited thereto.

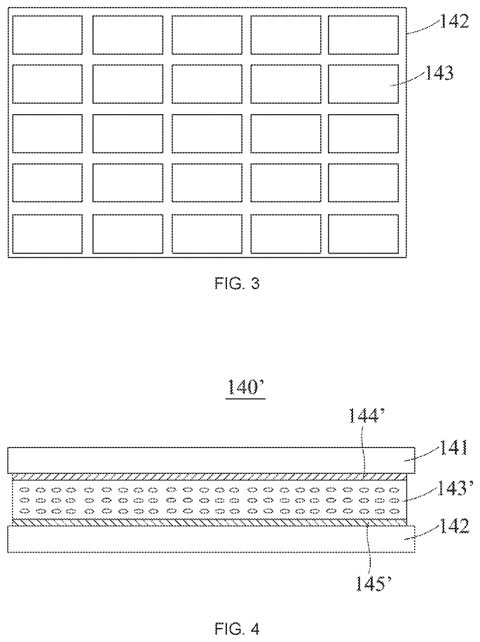

FIG. 2 is a schematic cross sectional diagram of a partitioning optical rotatory cell according to one embodiment of the present invention. FIG. 3 is a schematic diagram of liquid crystal grids disposed between the first substrate and the second substrate according to one embodiment of the present invention.

Referring to FIGS. 2 and 3, the partitioning optical rotatory cell 140 according to an embodiment of the present invention includes a first substrate 141, a second substrate 142 and plural liquid crystal grids 143.

The first substrate 141 is disposed facing and in parallel with the second substrate 142. The plural liquid crystal grids 143 are arranged in an array form and are disposed between the first substrate 141 and the second substrate 142. In the embodiment, for example, a sealant may be used to partition between the first substrate 141 and the second substrate 142 to form the plural liquid crystal grids 143. Each liquid crystal grid 143 includes plural liquid crystal molecules that are arranged in a TN form, the long axis direction of the liquid crystal molecules is in parallel with the first substrate 141 or the second substrate 142, and the liquid crystal molecules in each liquid crystal grid 143 are twisted independently, such that each liquid crystal grid 143 independently rotates the polarization direction of the illumination. Here, the plural liquid crystal grids 143 are disposed in a uniform array form and between the first substrate 141 and the second substrate 142, but the present invention is not limited thereto. For example, the plural liquid crystal grids 143 may be disposed between the first substrate 141 and the second substrate 142 in an arrangement in which the peripheral area has a high arrangement density while the central area has a low arrangement density, or may be disposed between the first substrate 141 and the second substrate 142 in another regular or irregular arrangement.

The partitioning optical rotatory cell 140 further includes plural first electrodes 144 and plural second electrodes 145. The shapes of the first electrodes 144 and the second electrodes 145 match those of the liquid crystal grids 143. The plural first electrodes 144 are arranged in an array form on a surface of the first substrate 141 facing the second substrate 142 and are mutually independent. The plural second electrodes 145 are arranged in an array form on a surface of the second substrate 142 facing the first substrate 141 and are mutually independent. Each liquid crystal grid 143 corresponds to a first electrode 144 and a second electrode 145, and the liquid crystal molecules in each liquid crystal grid 143 can be twisted independently by applying voltages to a first electrode 144 and a second electrode 145 corresponding to each liquid crystal grid 143 independently. In the embodiment, the liquid crystal grids 143 have a rectangular shape, but the present invention is not limited thereto. For example, the liquid crystal grids 143 may have a rhombus shape, a triangular shape, a regular pentagonal shape, a regular hexagonal shape, a regular octagonal shape and another suitable shape.

In detail, if the light transmission axis of the third polarizer 150 is perpendicular to that of the second polarizer 130, when applying a voltage to the corresponding liquid crystal grid 143 through the first electrode 144 and the second electrode 145, the liquid crystal molecules in the voltage-applied liquid crystal grid 143 are twisted, such that these liquid crystal molecules are perpendicular to the first substrate 141 or the second substrate 142, and therefore the partitioning optical rotatory cell 140 loses its optical rotation effect; because the light transmission axis of the third polarizer 150 is perpendicular to that of the second polarizer 130, the illumination penetrating through the third polarizer 150 cannot penetrate through the second polarizer 130, and therefore the area of the liquid crystal cell 110 corresponding to the voltage-applied liquid crystal grid 143 cannot display. When not applying voltages to the first electrode 144 and the second electrode 145 to which the liquid crystal grid 143 corresponds, the partitioning optical rotatory cell 140 has an optical rotation effect, and the illumination passing through the third polarizer 150 is rotated by 90°, such that the polarization direction of the illumination after 90° rotation is in parallel with the light transmission axis of the second polarizer 130, and therefore the area of the liquid crystal cell 110 corresponding to the voltage-applied liquid crystal grid 143 displays normally.

In contrast, if the light transmission axis of the third polarizer 150 is in parallel with that of the second polarizer 130, when applying a voltage to the corresponding liquid crystal grid 143 through the first electrode 144 and the second electrode 145, the liquid crystal molecules in the voltage-applied liquid crystal grid 143 are twisted, such that these liquid crystal molecules are perpendicular to the first substrate 141 or the second substrate 142, and therefore the partitioning optical rotatory cell 140 loses its optical rotation effect; because the light transmission axis of the third polarizer 150 is in parallel to that of the second polarizer 130, the illumination penetrating through the third polarizer 150 can penetrate through the second polarizer 130, and therefore the area of the liquid crystal cell 110 corresponding to the voltage-applied liquid crystal grid 143 can display normally. When not applying voltages to the first electrode 144 and the second electrode 145 to which the liquid crystal grid 143 corresponds, the partitioning optical rotatory cell 140 has an optical rotation effect, and the illumination passing through the third polarizer 150 is rotated by 90°, such that the polarization direction of the illumination after 90° rotation is perpendicular to the light transmission axis of the second polarizer 130, and therefore the area of the liquid crystal cell 110 corresponding to the voltage-applied liquid crystal grid 143 cannot display.

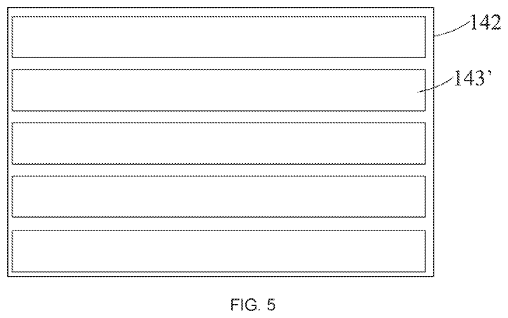

FIG. 4 is a schematic cross sectional diagram of a partitioning optical rotatory cell according to another embodiment of the present invention. FIG. 5 is a schematic diagram of liquid crystal strips disposed between the first substrate and the second substrate according to another embodiment of the present invention.

Referring to FIGS. 4 and 5, the partitioning optical rotatory cell 140′ according to another embodiment of the present invention includes the first substrate 141, the second substrate 142 and a plural liquid crystal strips 143′.

The first substrate 141 is disposed facing and in parallel with the second substrate 142. The plural liquid crystal strips 143′ are arranged in parallel with each other along a column direction and are disposed between the first substrate 141 and the second substrate 142, each liquid crystal strip 143′ extends along a row direction, and only one liquid crystal strip 143′ is in the row direction. In other words, each liquid crystal strip 143′ extends from the left side of the first substrate 141 (or the second substrate 142) to the right side of the first substrate 141 (or the second substrate 142) along the row direction. In the embodiment, for example, a sealant may be used to partition between the first substrate 141 and the second substrate 142 to form the plural liquid crystal strip 143′. Each liquid crystal strip 143′ includes plural liquid crystal molecules that are arranged in a TN form, the long axis direction of the liquid crystal molecules is in parallel with the first substrate 141 or the second substrate 142, and the liquid crystal molecules in each liquid crystal strip 143′ are twisted independently, such that each liquid crystal strip 143′ independently rotates the polarization direction of the illumination. In addition, in another embodiment of the present invention, the plural liquid crystal strips 143′ are arranged in parallel with each other along a row direction and are disposed between the first substrate 141 and the second substrate 142, each liquid crystal strip 143′ extends along a column direction, and only one liquid crystal strip 143′ is in the column direction.

The partitioning optical rotatory cell 140 further includes plural first electrode strips 144′ and plural second electrode strips 145′. The shapes of first electrode strips 144′ and the second electrode strips 145′ match those of the liquid crystal strips 143′. The plural first electrode strips 144′ are arranged in parallel with each other along a column direction and on a surface of the first substrate 141 facing the second substrate 142 and are mutually independent. The plural second electrode strips 145′ are arranged in parallel with each other along the column direction and on a surface of the second substrate 141 facing the first substrate 142 and are mutually independent. Each liquid crystal strip 143′ corresponds to a first electrode strip 144′ and a second electrode strip 145′, and the liquid crystal molecules in each liquid crystal strip 143′ can be twisted independently by applying voltages to a first electrode strip 144′ and a second electrode strip 145′ corresponding to each liquid crystal strip 143′ independently.

In detail, if the light transmission axis of the third polarizer 150 is perpendicular to that of the second polarizer 130, when applying a voltage to the corresponding liquid crystal strip 143′ through the first electrode strip 144′ and the second electrode strip 145′, the liquid crystal molecules in the voltage-applied liquid crystal strip 143′ are twisted, such that these liquid crystal molecules are perpendicular to the first substrate 141 or the second substrate 142, and therefore the partitioning optical rotatory cell 140 loses its optical rotation effect; because the light transmission axis of the third polarizer 150 is perpendicular to that of the second polarizer 130, the illumination penetrating through the third polarizer 150 cannot penetrate through the second polarizer 130, and therefore the area of the liquid crystal cell 110 corresponding to the voltage-applied liquid crystal strip 143′ cannot display. When not applying voltages to the first electrode strip 144′ and the second electrode strip 145′ to which the liquid crystal strip 143′ corresponds, the partitioning optical rotatory cell 140 has an optical rotation effect, and the illumination passing through the third polarizer 150 is rotated by 90°, such that the polarization direction of the illumination after 90° rotation is in parallel with the light transmission axis of the second polarizer 130, and therefore the area of the liquid crystal cell 110 corresponding to the voltage-applied liquid crystal strip 143′ displays normally.

In contrast, if the light transmission axis of the third polarizer 150 is in parallel with that of the second polarizer 130, when applying a voltage to the corresponding liquid crystal strip 143′ through the first electrode strip 144′ and the second electrode strip 145′, the liquid crystal molecules in the voltage-applied liquid crystal grid 143 are twisted, such that these liquid crystal molecules are perpendicular to the first substrate 141 or the second substrate 142, and therefore the partitioning optical rotatory cell 140 loses its optical rotation effect; because the light transmission axis of the third polarizer 150 is in parallel to that of the second polarizer 130, the illumination penetrating through the third polarizer 150 can penetrate through the second polarizer 130, and therefore the area of the liquid crystal cell 110 corresponding to the voltage-applied liquid crystal strip 143′ can display normally. When not applying voltages to the first electrode strip 144′ and the second electrode strip 145′ to which the liquid crystal strip 143′ corresponds, the partitioning optical rotatory cell 140 has an optical rotation effect, and the illumination passing through the third polarizer 150 is rotated by 90°, such that the polarization direction of the illumination after 90° rotation is perpendicular to the light transmission axis of the second polarizer 130, and therefore the area of the liquid crystal cell 110 corresponding to the voltage-applied liquid crystal strip 143′ cannot display.

In summary, according to the various embodiments of the present invention, a partitioning optical rotatory cell is inserted in a liquid crystal panel to form a display panel that can achieve brightness control to partitions, thereby improving the dynamic image contrast for display.

Although the present disclosure is described with reference to the special exemplary embodiments, it will be understood by those skilled in the art that various changes in form and details may be made therein without departing from the spirit and scope of the present invention as defined by the following claims and its equivalents.

What is claimed is:

1. A display panel, comprising:
a liquid crystal panel;
a partitioning optical rotatory cell disposed opposite to the liquid crystal panel; and
a polarizer disposed on a side the partitioning optical rotatory cell facing away from the liquid crystal panel, a light transmission axis of the polarizer perpendicular to or in parallel with a light transmission axis of a lower polarizer of the liquid crystal panel;
wherein the partitioning optical rotatory cell is configured to perform a regionally rotatory process on a polarization direction of illumination passing through the polarizer, such that different areas of the liquid crystal panel have different luminances.

2. The display panel according to claim herein the partitioning optical rotatory cell comprises;
a first substrate;
a second substrate disposed facing and in parallel with the first substrate;
a plurality of liquid crystal grids disposed between the first substrate and the second substrate, each liquid crystal grid having a plurality of liquid crystal molecules therein, the liquid crystal molecules arranged in a twisted nematic (TN) form, a long axis direction of the liquid crystal molecules in parallel with the first substrate, the liquid crystal molecules in each liquid crystal grid twisted independently.

3. The display panel according to claim 2, wherein the partitioning optical rotatory cell further comprises:
a plurality of first electrodes disposed on a surface of the first substrate facing the second substrate, the first electrodes being mutually independent;
a plurality of second electrodes disposed on a surface of the second substrate facing the first substrate, the second electrodes being mutually independent;
wherein each liquid crystal grid corresponds to a first electrode and a second electrode.

4. The display panel according to claim 2, wherein the plurality of liquid crystal grids comprise at least one of a rectangular liquid crystal grid, a rhombus liquid crystal grid, a triangular liquid crystal grid, a regular pentagonal liquid crystal grid, a regular hexagonal liquid crystal grid and a regular octagonal liquid crystal grid.

5. The display panel according to claim 3, wherein the plurality of liquid crystal grids comprise at least one of a rectangular liquid crystal grid, a rhombus liquid crystal grid, a triangular liquid crystal grid, a regular pentagonal liquid crystal grid, a regular hexagonal liquid crystal grid and a regular octagonal liquid crystal grid.

6. The display panel according to claim 2, wherein the plurality of liquid crystal grids are arranged in an array form and between the first substrate and the second substrate.

7. The display panel according to claim 3, wherein the plurality of liquid crystal grids are arranged in an array form and between the first substrate and the second substrate.

8. The display panel according to claim herein the partitioning optical rotatory cell comprises:
a first substrate;
a second substrate disposed facing and in parallel with the first substrate;
a plurality of liquid crystal strips disposed between the first substrate and the second substrate, the plurality of liquid crystal strips arranged in parallel with each other along a first direction, each liquid crystal strip extending along a second direction that is perpendicular to the first direction, each liquid crystal strip having a plurality of liquid crystal molecules therein, the plurality of liquid crystal molecules arranged in a TN form, a long axis direction of the liquid crystal molecules in parallel with the first substrate, and the liquid crystal molecules of each liquid crystal grid twisted independently.

9. The display panel according to claim 8, wherein the partitioning optical rotatory cell further comprises:
a plurality of first electrode strips arranged in parallel with each other along the first direction and on a surface of the first substrate facing the second substrate, the first electrode strips being mutually independent;
a plurality of second electrode strips arranged in parallel with each other along the first direction and disposed on a surface of the second substrate facing the first substrate, the second electrode strips being mutually independent;
wherein each liquid crystal strip corresponds to one of the first electrode strips and one of the second electrode strips.

10. The display panel according to claim 1, wherein the liquid crystal panel comprises:
a liquid crystal cell disposed opposite to the partitioning optical rotatory cell;
the lower polarizer disposed between the liquid crystal cell and the partitioning optical rotatory cell; and
an upper polarizer disposed on a side of the liquid crystal cell facing away from the partitioning optical rotatory cell.

11. A display device comprising a backlight module and the display panel according to claim 1, the backlight module disposed on a side of the polarizer facing away from the partitioning optical rotatory cell.

12. The display device according to claim 11, wherein the backlight module is a side-edge backlight module or a direct backlight module.
